(19) United States
(12) Patent Application Publication
(10) Pub. No.: US 2025/0055061 A1
(43) Pub. Date: Feb. 13, 2025

(54) ENERGY STORAGE CELL AND ENERGY STORAGE MODULE INCLUDING THE SAME

(71) Applicant: TOYOTA JIDOSHA KABUSHIKI KAISHA, Toyota-shi (JP)

(72) Inventors: Kazuhito KATO, Toyota-shi (JP); Junta Takasu, Nagoya-shi (JP); Atsushi Yamanaka, Nagoya-shi (JP); Masato Ono, Nagoya-shi (JP); Satoshi Moriyama, Nagoya-shi (JP); Kosuke Suzuki, Toyota-shi (JP); Kazuki Sugie, Miyoshi-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 18/659,031

(22) Filed: May 9, 2024

(30) Foreign Application Priority Data
Aug. 9, 2023 (JP) 2023-129904

(51) Int. Cl. H01M 10/654; H01M 10/04; H01M 10/613; H01M 10/6551; H01M 50/103

(52) U.S. Cl. CPC H01M 10/654; H01M 10/613; H01M 10/6551; H01M 10/0431; H01M 50/103

(57) ABSTRACT

An energy storage cell according to the present disclosure includes a wound electrode assembly and a cell case. The cell case includes an outer peripheral wall portion, a first end portion, a second end portion, and an inner peripheral wall portion. The first end portion has a first hole. The second end portion has a second hole. The inner peripheral wall portion extends from the first hole to the second hole. The inner peripheral wall portion is disposed inside the wound electrode assembly in a radial direction. A portion of the outer peripheral wall portion that is located next to the wound electrode assembly in the radial direction has a rectangular tubular outer shape. A portion of the inner peripheral wall portion that is located next to the wound electrode assembly in the radial direction has a rectangular tubular outer shape.

### CROSS-REFERENCE TO RELATED APPLICATION

This application claims priority to Japanese Patent Application No. 2023-129904 filed on Aug. 9, 2023, incorporated herein by reference in its entirety.

### BACKGROUND

### 1. Technical Field

The present disclosure relates to energy storage cells and energy storage modules including the same.

### 2. Description of Related Art

Japanese Unexamined Patent Application Publication No. 2001-093566 (JP 2001-093566 A) discloses a cylindrical battery characterized in that a core of the cylindrical battery is a hollow member so that air is allowed to flow through a hollow portion of the hollow member. JP 2001-093566 A describes that the above configuration enhances the heat dissipation effect and prevents degradation in performance of the cylindrical battery.

### SUMMARY

In order to increase the capacity of an energy storage module, it is required to arrange a plurality of energy storage cells as densely as possible in the energy storage module.

JP 2001-093566 A describes that the battery disclosed therein enhances the heat dissipation effect. However, it cannot be said that the heat dissipation effect by the hollow portion described in JP 2001-093566 A is sufficient when a plurality of energy storage cells is more densely arranged in an energy storage module.

The present disclosure was made in view of the above problem, and it is an object of the present disclosure to provide an energy storage cell and energy storage module including the same that can increase the capacity of the energy storage module including the energy storage cell and improve the heat dissipation properties of the energy storage cell.

An energy storage cell according to the present disclosure includes a wound electrode assembly and a cell case. The cell case houses the wound electrode assembly. The cell case includes an outer peripheral wall portion, a first end portion, a second end portion, and an inner peripheral wall portion. The outer peripheral wall portion has a tubular shape and is disposed outside the wound electrode assembly in a radial direction. The first end portion is connected to one side of the outer peripheral wall portion in an axial direction of the wound electrode assembly. The first end portion has a first hole extending through the first end portion in the axial direction. The second end portion is connected to another side of the outer peripheral wall portion in the axial direction. The second end portion has a second hole extending through the second end portion in the axial direction. The inner peripheral wall portion extends from the first hole to the second hole. The inner peripheral wall portion is disposed inside the wound electrode assembly in the radial direction. A portion of the outer peripheral wall portion that is located next to the wound electrode assembly in the radial direction has a rectangular tubular outer shape. A portion of the inner peripheral wall portion that is located next to the wound electrode assembly in the radial direction has a rectangular tubular outer shape.

According to the present disclosure, the capacity of an energy storage module including an energy storage cell can be increased, and the heat dissipation properties of the energy storage cell can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of an energy storage cell according to a first embodiment of the present disclosure;

FIG. 2 is a cross-sectional view of the energy storage cell of FIG. 1 as viewed from II-II line arrow;

FIG. 3 is a cross-sectional view schematically showing an energy storage module according to the first embodiment of the present disclosure;

FIG. 4 is a perspective view showing a plurality of energy storage cells included in the energy storage module according to the first embodiment of the present disclosure;

FIG. 5 is a partial cross-sectional view showing a part of the energy storage module according to the first embodiment of the present disclosure; and

FIG. 6 is a cross-sectional view illustrating an energy storage module according to a second embodiment of the present disclosure.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

### First Embodiment

First, an energy storage cell according to a first embodiment of the present disclosure will be described. The energy storage cell described below is, for example, a lithium-ion battery mounted on a vehicle. Note that the use and type of the energy storage cell are not limited to the above-described examples.

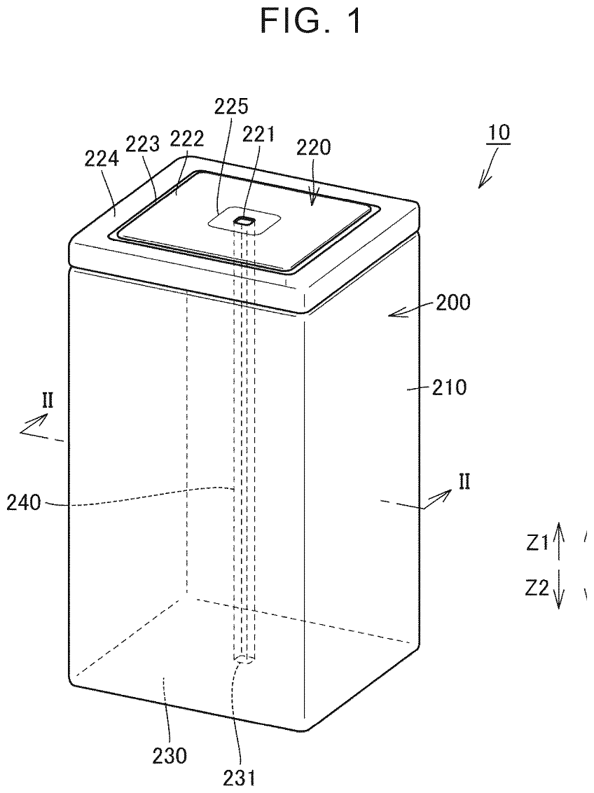

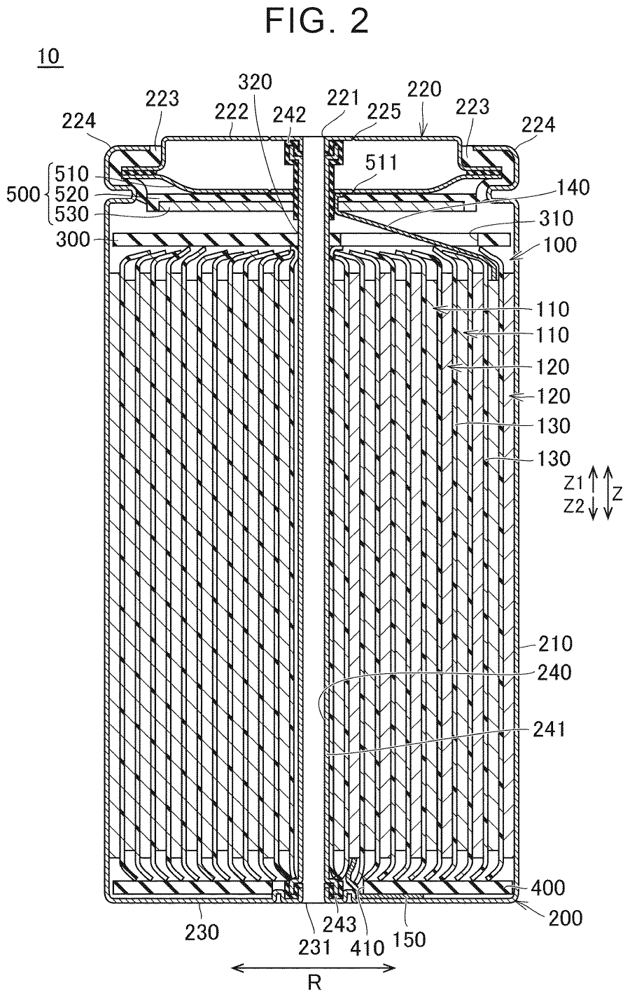

FIG. 1 is a perspective view of an energy storage cell according to a first embodiment of the present disclosure. FIG. 2 is a sectional view of the energy storage cell of FIG. 1 as viewed from a II-II line arrow.

As shown in FIGS. 1 and 2, the energy storage cell 10 is a rectangular tubular battery. It should be noted that “rectangle” herein may include squares, rectangles, and substantially squares having rounded corners, and the like. That is, a “rectangle” herein may have two sets of sides that are generally parallel to each other. The energy storage cell 10 includes a wound electrode assembly 100 and a cell case 200.

As shown in FIG. 2, the wound electrode assembly 100 includes a positive electrode plate 110, a negative electrode plate 120, a separator 130, a positive electrode tab lead 140, and a negative electrode tab lead 150. The separator 130 is provided between the positive electrode plate 110 and the negative electrode plate 120. The separator 130 separates the positive electrode plate 110 and the negative electrode plate 120 while allowing ions (for example, lithium ions) to move back and forth between the positive electrode plate 110 (positive electrode active material) and the negative electrode plate 120 (negative electrode active material). The wound electrode assembly 100 is constituted by an electrode plate group in which a positive electrode plate 110 and a negative electrode plate 120 are wound with a separator 130 interposed therebetween.

The positive electrode plate 110 includes a positive electrode current collector and a positive electrode mixture layer. The positive electrode mixture layer is coated on a part of the positive electrode current collector. That is, the positive electrode current collector includes a coating portion coated with the positive electrode mixture layer and an uncoated portion not coated with the positive electrode mixture layer.

For example, aluminum or the like is used as the positive electrode current collector. The positive electrode mixture layer is formed by coating a positive electrode slurry on the surface of a positive electrode current collector and drying the positive electrode slurry. The positive electrode slurry is a slurry prepared by kneading a material (a positive electrode active material, a binder, or the like) of the positive electrode mixture layer and a solvent. The positive electrode mixture layer is in close contact with the separator 130. The thickness of the positive electrode mixture layer is, for example, 0.1 μm or more and 1000 μm or less.

The negative electrode plate 120 includes a negative electrode current collector and a negative electrode mixture layer. The negative electrode mixture layer is coated on a part of the negative electrode current collector. That is, the negative electrode current collector includes a coating portion on which the negative electrode mixture layer is coated and an uncoated portion on which the negative electrode mixture layer is not coated.

For example, copper foil or the like is used as the negative electrode current collector. The negative electrode mixture layer is formed by coating the negative electrode slurry on the surface of the negative electrode current collector and drying the negative electrode slurry. The negative electrode slurry is a slurry prepared by kneading a material (a negative electrode active material, a binder, and the like) of the negative electrode mixture layer and a solvent. The negative electrode mixture layer is in close contact with the separator 130. The thickness of the negative electrode mixture layer is, for example, 0.1 μm or more and 1000 μm or less.

The positive electrode tab lead 140 is provided so as to protrude from the positive electrode current collector of the positive electrode plate 110 toward one side (Z1 side) in the axial direction Z.

The negative electrode tab lead 150 is provided so as to protrude from the negative electrode current collector of the negative electrode plate 120 toward the other side (Z2 side) in the axial direction Z.

The cell case 200 houses the wound electrode assembly 100. The cell case 200 has a substantially rectangular tubular outer shape. Therefore, the energy storage cell 10 is a rectangular tubular battery.

The cell case 200 includes an outer peripheral wall portion 210, a first end portion 220, a second end portion 230, and an inner peripheral wall portion 240.

The outer peripheral wall portion 210 has a tubular shape and is disposed outside the wound electrode assembly 100 in the radial direction R. A portion of the outer peripheral wall portion 210 that is located next to the wound electrode assembly 100 in the radial direction R has a rectangular tubular outer shape. The outer peripheral wall portion 210 is made of copper, aluminum, or the like. The outer peripheral wall portion 210 is in contact with the negative electrode current collector of the negative electrode plate 120 provided on the outermost periphery of the wound electrode assembly 100.

The first end portion 220 is connected to one side (Z1 side) of the outer peripheral wall portion 210 in the axial direction Z of the wound electrode assembly 100. The first end portion 220 is connected to one side (Z1 side) of the outer peripheral wall portion 210 in the axial direction Z of the wound electrode assembly 100. The first end portion 220 has a first hole 221 penetrating in the axial direction Z.

Specifically, the first end portion 220 includes an outer cap 222, an insulating layer 223, and a caulking portion 224.

The outer cap 222 has a function as an external terminal by being electrically connected to a bus bar (described later in detail). The outer cap 222 is provided with a fragile portion 225 (thin portion). When the internal pressure of the cell case 200 increases, the outer cap 222 is easily broken starting from the fragile portion 225. As a result, the gas is rapidly discharged to the outside of the cell case 200. The first hole 221 is provided in the outer cap 222. The outer cap 222 is made of copper, aluminum, or the like.

The insulating layer 223 is disposed so as to cover the outer peripheral end of the outer cap 222. The insulating layer 223 is provided to insulate the outer cap 222 from the caulking portion 224.

The caulking portion 224 is connected to one side of the outer peripheral wall portion 210 in the axial direction Z of the wound electrode assembly 100. The caulking portion 224 is integrally formed with the outer peripheral wall portion 210. The caulking portion 224 caulks the outer peripheral edge of the outer cap 222 (and the conductive film 510 to be described later) via the insulating layer 223. The caulking portion 224 is made of copper, aluminum, or the like.

The second end portion 230 is connected to the other side of the outer peripheral wall portion 210 in the axial direction Z. The second end portion 230 has a second hole 231 penetrating in the axial direction Z.

The second end portion 230 has a rectangular plate-like outer shape. The second end portion 230 is formed of copper, aluminum, or the like. A peripheral edge of the second end portion 230 is connected to the outer peripheral wall portion 210. The second end portion 230 is integrally formed with the outer peripheral wall portion.

The second end portion 230 is in contact with the negative electrode tab lead 150. Accordingly, the negative electrode tab lead 150 and the second end portion 230 are electrically connected to each other. As a result, the outer peripheral wall portion 210 and the caulking portion 224 connected to the second end portion 230 and the second end portion 230 are negatively charged.

The inner peripheral wall portion 240 extends from the first hole 221 to the second hole 231. The inner peripheral wall portion 240 is disposed inside the wound electrode assembly 100 in the radial direction R. A portion of the inner peripheral wall portion 240 that is located next to the wound electrode assembly 100 in the radial direction R has a rectangular tubular outer shape.

The inner peripheral wall portion 240 includes a core portion 241, a first insulating end portion 242, and a second insulating end portion 243.

The core portion 241 has a rectangular tubular outer shape. The core portion 241 is disposed inside the wound electrode assembly 100 in the radial direction R. The core portion 241 may be used as a core material when the electrode plate group is wound to form the wound electrode assembly 100. From the viewpoint of the heat dissipation properties, the core portion 241 is preferably formed of a metal such as copper or aluminum.

The first insulating end portion 242 is disposed on one side (Z1 side) of the core portion 241. The first insulating end portion 242 insulates the core portion 241 from the first end portion 220 (the outer cap 222). The core portion 241 is connected to the first end portion 220 (the outer cap 222) via the first insulating end portion 242.

The second insulating end portion 243 is disposed on the other side (Z2 side) of the core portion 241. The second insulating end portion 243 insulates the core portion 241 from the second end portion 230. The core portion 241 is connected to the second end portion 230 via the second insulating end portion 243.

The energy storage cell 10 further includes a positive side insulating plate 300, a negative side insulating plate 400, and a Current Interrupt Device (CID) 500.

The positive side insulating plate 300 is accommodated in the cell case 200. The positive side insulating plate 300 is provided so as to insulate the wound electrode assembly 100 (the negative electrode plate 120 and the separator 130) from the cell case 200. The positive side insulating plate 300 is provided so as to cover the positive electrode plate 110, the negative electrode plate 120, and the separator 130 from one side (Z1 side).

The positive side insulating plate 300 has a first through hole 310 and a second through hole 320. The positive electrode tab lead 140 is inserted through the first through hole 310 and is in contact with the conductive film 510 described later. Thus, the positive electrode tab lead 140 and the conductive film 510 are electrically connected to each other. An inner peripheral wall portion 240 (core portion 241) is inserted into the second through hole 320.

The negative side insulating plate 400 is accommodated in the cell case 200. The negative side insulating plate 400 is provided so as to insulate the wound electrode assembly 100 (the positive electrode plate 110 and the separator 130) from the cell case 200. The negative side insulating plate 400 is provided so as to cover the positive electrode plate 110, the negative electrode plate 120, and the separator 130 from the other side (Z2 side).

The negative side insulating plate 400 has a through hole 410. The negative electrode tab lead 150 is inserted into the through hole 410. Accordingly, the negative electrode tab lead 150 and the second end portion 230 are electrically connected to each other. The inner peripheral wall portion 240 (the core portion 241 and the second insulating end portion 243) is also inserted into the through hole 410.

CID 500 is a device that cuts off the current path by utilizing an increase in the internal pressure of the cell caused by the gases generated due to overcharge of the energy storage cell 10. CID 500 is provided so as to seal the opening on one side (Z1 side) of the outer peripheral wall portion 210. CID 500 includes a conductive film 510, a gasket 520, and a bottom disk 530.

The conductive film 510 is provided so as to seal an opening on one side (Z1 side) of the outer peripheral wall portion 210. The conductive film 510 is in contact with the positive electrode tab lead 140. Thus, the conductive film 510 is positively charged. The conductive film 510 is electrically connected to the outer cap 222 by a connecting member (not shown). As a result, the outer cap 222 is also positively charged.

Like the outer cap 222, the conductive film 510 is provided with a fragile portion 511 (thin portion). When the internal pressure of the cell case 200 increases, the conductive film 510 is easily broken starting from the fragile portion 511. When the conductive film 510 is broken due to an increase in the internal pressure, the contact between the conductive film 510 and the positive electrode tab lead 140 is released. As a result, the positive charge of the conductive film 510 is eliminated, and the positive charge of the outer cap 222 is eliminated. As a result, charging and discharging of the energy storage cell 10 are stopped.

The gasket 520 is positioned on the wound electrode assembly 100 side of the conductive film 510. The bottom disk 530 is connected to the conductive film 510 via a gasket 520.

The core portion 241 and the first insulating end portion 242 of the inner peripheral wall portion 240 pass through CID 500. Specifically, the core portion 241 and the first insulating end portion 242 penetrate the conductive film 510, the gasket 520, and the bottom disk 530.

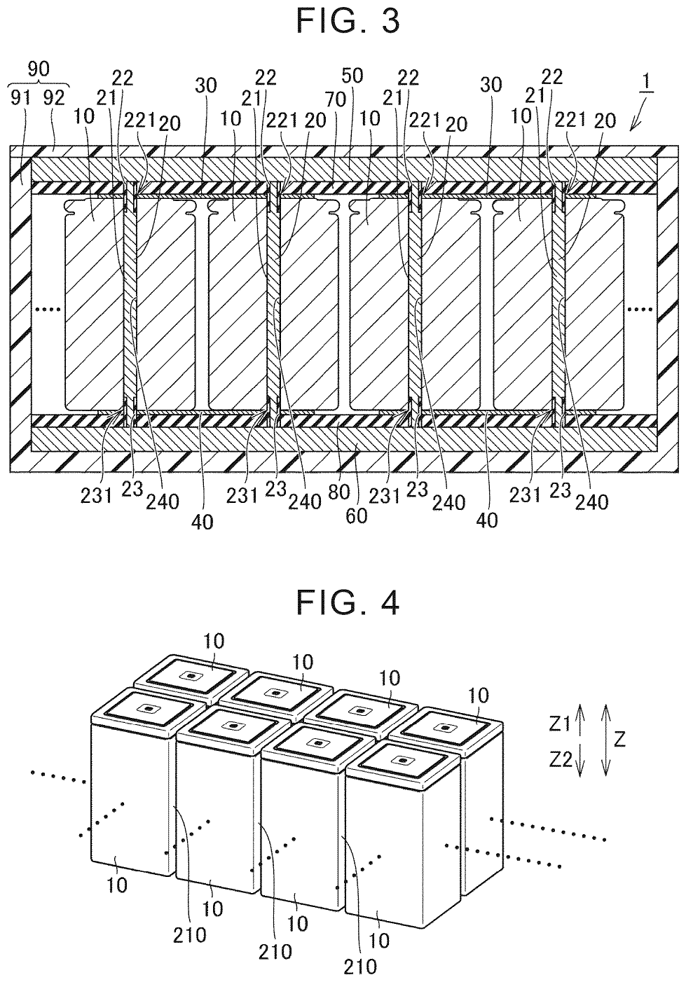

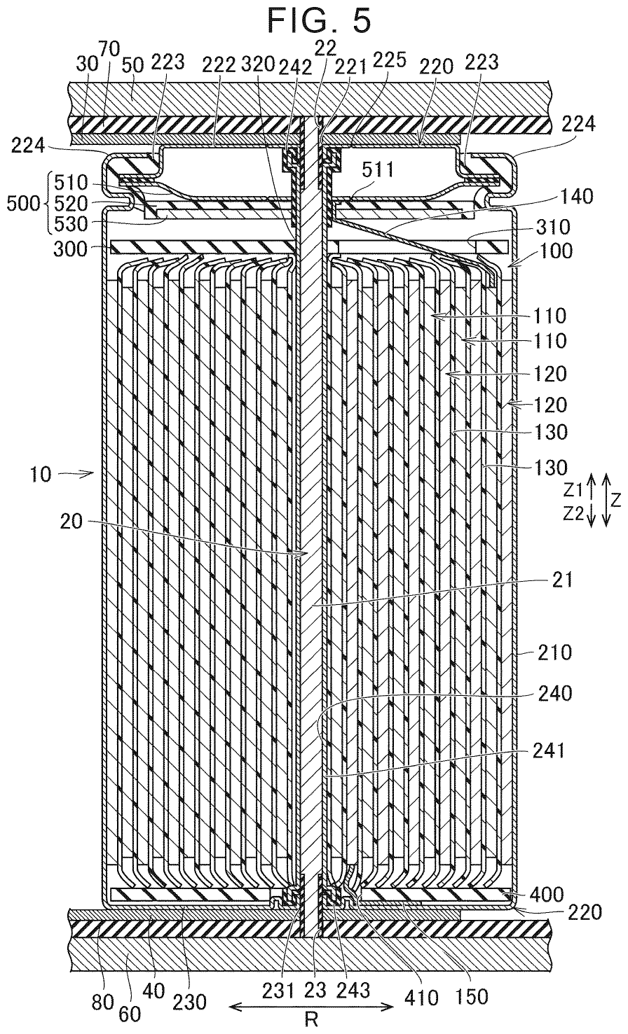

Next, an energy storage module according to the first embodiment of the present disclosure will be described. FIG. 3 is a cross-sectional view schematically showing an energy storage module according to the first embodiment of the present disclosure. FIG. 4 is a perspective view illustrating a plurality of energy storage cells included in the energy storage module according to the first embodiment of the present disclosure. FIG. 5 is a partial cross-sectional view illustrating a part of the energy storage module according to the first embodiment of the present disclosure. In FIG. 3, a cross-sectional view of the energy storage cell 10 is schematically shown.

As illustrated in FIGS. 3 to 5, in the energy storage module 1 according to the first embodiment of the present disclosure, the energy storage module 1 includes one or more energy storage cells 10 and one or more cooling members 20.

The energy storage module 1 according to the present embodiment includes a plurality of energy storage cells 10. The plurality of energy storage cells 10 are arranged such that the axial direction Z of the wound electrode assembly 100 in each of the energy storage cells 10 is parallel to each other. In each of the plurality of energy storage cells 10, a planar portion of the outer peripheral wall portion 210 faces a planar portion of the outer peripheral wall portion 210 of the other adjacent energy storage cells 10. A plurality of energy storage cells 10 are arranged so that the planar portions are parallel to each other.

For each energy storage cell 10, each of the plurality of cooling members 20 is disposed inside the inner peripheral wall portion 240 in the radial direction R of the energy storage cell 10. The cooling member 20 is in contact with the inner peripheral wall portion 240 of the energy storage cell 10. The cooling member 20 extends from the inside of the first hole 221 to the inside of the second hole 231 in the axial direction Z of the corresponding energy storage cell 10. The cooling member 20 is disposed so as to penetrate the energy storage cell 10 in the axial direction Z.

The cooling member 20 includes a metal portion 21, a first insulating covering portion 22, and a second insulating covering portion 23.

The metal portion 21 is made of a metal such as aluminum or copper. The metal portion 21 extends from the inside of the first hole 221 to the inside of the second hole 231 in the axial direction Z of the corresponding energy storage cell 10. A portion of the metal portion 21 that is located next to the wound electrode assembly 100 of a corresponding one of the energy storage cells 10 in the radial direction R forms at least part of the outer surface of the cooling member 20. The metal portion 21 is in contact with only the core portion 241 of the inner peripheral wall portion 240.

The first insulating covering portion 22 is covered with a part of the outer surface of the metal portion 21 in the radial direction R. The first insulating covering portion 22 is in contact with the first end portion 220 of the corresponding energy storage cell 10. The first insulating covering portion 22 electrically insulates the first end portion 220 and the metal portion 21 from each other.

The second insulating covering portion 23 is covered with another part of the outer surface of the metal portion 21 in the radial direction R. The second insulating covering portion 23 is in contact with the second end portion 230 of the corresponding energy storage cell 10. The second insulating covering portion 23 electrically insulates the second end portion 230 and the metal portion 21 from each other.

The energy storage module 1 may further include one or more first bus bars 30 and one or more second bus bars 40. The first bus bar and/or the second bus bar 40 electrically connect two or more energy storage cells 10.

The one or more first bus bars 30 are electrically connected to the first end portions 220 of the plurality of energy storage cells 10. The one or more second bus bars 40 are electrically connected to the second end portions 230 of the plurality of energy storage cells 10. When the energy storage module 1 includes the plurality of first bus bars 30 and the plurality of second bus bars 40, the first bus bars 30 may be electrically connected to the other first bus bars 30. The second bus bar 40 may be electrically connected to another second bus bar 40. The first bus bar 30 may be electrically connected to the second bus bar 40 connected to the energy storage cell 10 to which the first bus bar 30 is not connected.

The energy storage module 1 further includes a first heat transfer portion 50 and a second heat transfer portion 60. The first heat transfer portion 50 is connected to one end of each cooling member 20 (metal portion 21). The second heat transfer portion 60 is connected to the other end of each cooling member 20 (metal portion 21). The first heat transfer portion 50 and the second heat transfer portion 60 function to help dissipate heat transferred from the energy storage cell 10 to the respective cooling members 20 (metal portions 21) to the outside of the energy storage module 1. The first heat transfer portion 50 and the second heat transfer portion 60 may also be made of a metal such as aluminum or copper.

The energy storage module 1 may further include a first insulating plate 70 and a second insulating plate 80. The first insulating plate 70 is disposed between the first bus bar 30 and the first heat transfer portion 50 and electrically insulates them from each other. The second insulating plate 80 is disposed between the second bus bar 40 and the second heat transfer portion 60 and electrically insulates them from each other.

The energy storage module 1 further includes a module case 90. The module case 90 houses the plurality of energy storage cells 10, the plurality of cooling members 20, the first bus bar 30, the second bus bar 40, the first heat transfer portion 50, the second heat transfer portion 60, the first insulating plate 70, and the second insulating plate 80.

The specific configuration of the module case 90 is not particularly limited. In the example illustrated in FIG. 3, the module case 90 includes a lower case 91 having an opening and an upper case 92 sealing the opening of the lower case 91. However, the module case 90 may not include the upper case 92. In this case, the opening of the lower case 91 may be sealed by the first heat transfer portion 50 or the first insulating plate 70.

As described above, the energy storage cell 10 according to the first embodiment of the present disclosure includes the wound electrode assembly 100 and the cell case 200. The cell case 200 houses the wound electrode assembly 100. The cell case 200 includes an outer peripheral wall portion 210, a first end portion 220, a second end portion 230, and an inner peripheral wall portion 240. The outer peripheral wall portion 210 has a tubular shape and is disposed outside the wound electrode assembly 100 in the radial direction R. The first end portion 220 is connected to one side of the outer peripheral wall portion 210 in the axial direction Z of the wound electrode assembly 100. The first end portion 220 is connected to one side of the outer peripheral wall portion 210 in the axial direction Z of the wound electrode assembly 100. The first end portion 220 has a first hole 221 penetrating in the axial direction Z. The second end portion 230 is connected to the other side of the outer peripheral wall portion 210 in the axial direction Z. The second end portion 230 has a second hole 231 penetrating in the axial direction Z. The inner peripheral wall portion 240 extends from the first hole 221 to the second hole 231. The inner peripheral wall portion 240 is disposed inside the wound electrode assembly 100 in the radial direction R. A portion of the outer peripheral wall portion 210 that is located next to the wound electrode assembly 100 in the radial direction R has a rectangular tubular outer shape. A portion of the inner peripheral wall portion 240 that is located next to the wound electrode assembly 100 in the radial direction R has a rectangular tubular outer shape.

According to the above configuration, since the above portion of the outer peripheral wall portion 210 has a rectangular tubular outer shape, the plurality of energy storage cells 10 can be densely arranged in the energy storage module 1 (see FIG. 4). Since the energy storage cells 10 can be densely arranged, the space in the cell case 200 per one energy storage cell 10 can be made wide in the energy storage module 1. Therefore, in the energy storage module 1, the size of the wound electrode assembly 100 per one energy storage cell 10 can be increased, and the capacity of the entire energy storage module 1 can be increased.

Further, according to the above configuration, since the above portion of the inner peripheral wall portion 240 has a rectangular tubular outer shape, the wound electrode assembly 100 can easily have a shape along the outer peripheral wall portion 210. In addition, since the portion of the inner peripheral wall portion 240 has a rectangular tubular outer shape, the outer surface area of the inner peripheral wall portion 240 is relatively increased. Therefore, even when the plurality of energy storage cells 10 are densely arranged, heat dissipation from the inner peripheral wall portion 240 can be improved.

Therefore, the energy storage cell 10 having the above-described configuration can increase the capacity of the energy storage module 1 including the energy storage cell 10, and can improve the heat dissipation properties of the energy storage cell.

The energy storage module 1 according to the first embodiment of the present disclosure includes one or more energy storage cells 10 and a cooling member 20. The cooling member 20 is disposed inside the inner peripheral wall portion 240 in the radial direction R of the energy storage cell 10. The cooling member 20 includes a metal portion 21. The metal portion 21 is made of a metal. The metal portion 21 extends from the inside of the first hole 221 to the inside of the second hole 231 in the axial direction Z of the corresponding energy storage cell 10. A portion of the metal portion 21 that is located next to the wound electrode assembly 100 of a corresponding one of the energy storage cells 10 in the radial direction R forms at least part of the outer surface of the cooling member 20.

According to the above configuration, heat generated from the energy storage cell 10 is easily discharged through the metal portion 21. Therefore, the cooling efficiency of the energy storage cell 10 in the energy storage module 1 can be further improved.

### Second Embodiment

Hereinafter, an energy storage module according to a second embodiment of the present disclosure will be described. The energy storage module according to the second embodiment of the present disclosure is mainly different from the energy storage module 1 according to the first embodiment of the present disclosure in the configuration of the cooling member. Therefore, description of the same configuration and effects as those of the energy storage module 1 according to the first embodiment of the present disclosure will not be repeated.

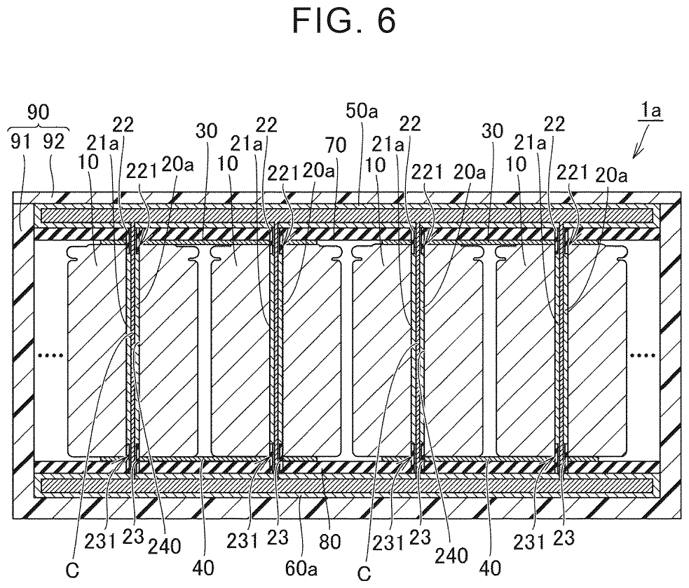

FIG. 6 is a cross-sectional view illustrating an energy storage module according to a second embodiment of the present disclosure. In FIG. 6, the energy storage module according to the second embodiment is shown in a cross-sectional view similar to that of FIG. 3 in the energy storage module 1 of the first embodiment.

As shown in FIG. 6, in the energy storage module 1a according to the second embodiment, the cooling member 20a extends from the inside of the first hole 221 to the inside of the second hole 231 in the axial direction (Z) of the corresponding energy storage cell 10. The cooling member 20a is configured to allow a cooling medium C to flow therethrough in the axial direction (Z).

According to the above configuration, by allowing the cooling medium C to flow through the cooling member 20a, heat generated from the energy storage cell 10 is easily discharged through the cooling member 20a. Therefore, the cooling-efficiency of the energy storage cell 10 in the energy storage module 1a can be further improved.

More specifically, in the cooling member 20a, the metallic portion 21a is configured to allow the cooling medium C to flow therethrough in the axial direction Z. In addition, the first heat transfer portion 50a and the second heat transfer portion 60a may be configured to store the cooling medium C therein. The first heat transfer portion 50a and the second heat transfer portion 60a and the cooling member 20a (metal portion 21a) may be configured to allow the cooling medium C to enter and exit between the first heat transfer portion 50a and the second heat transfer portion 60a, and the cooling member 20a. The first heat transfer portion 50a and the second heat transfer portion 60a may further have a function as a cooler for cooling the cooling medium C.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. An energy storage cell comprising:
a wound electrode assembly; and
a cell case that houses the wound electrode assembly, wherein
the cell case includes
a tubular outer peripheral wall portion disposed outside the wound electrode assembly in a radial direction,
a first end portion connected to one side of the outer peripheral wall portion in an axial direction of the wound electrode assembly and having a first hole extending through the first end portion in the axial direction,
a second end portion connected to another side of the outer peripheral wall portion in the axial direction and having a second hole extending through the second end portion in the axial direction, and
an inner peripheral wall portion extending from the first hole to the second hole and disposed inside the wound electrode assembly in the radial direction,
a portion of the outer peripheral wall portion that is located next to the wound electrode assembly in the radial direction has a rectangular tubular outer shape, and
a portion of the inner peripheral wall portion that is located next to the wound electrode assembly in the radial direction has a rectangular tubular outer shape.

2. An energy storage module comprising:
one or more of the energy storage cells according to claim 1; and
a cooling member disposed inside the inner peripheral wall portion of the energy storage cell in the radial direction of the energy storage cell, wherein
the cooling member includes a metal portion made of metal,
the metal portion extends from inside of the first hole to inside of the second hole in the axial direction of a corresponding one of the energy storage cells, and
a portion of the metal portion that is located next to the wound electrode assembly of the corresponding one of the energy storage cells in the radial direction forms at least part of an outer surface of the cooling member.

3. An energy storage module comprising:
one or more of the energy storage cells according to claim 1; and
a cooling member disposed inside the inner peripheral wall portion in the radial direction of the energy storage cell, wherein
the cooling member extends from inside of the first hole to inside of the second hole in the axial direction of a corresponding one of the energy storage cells, and is configured to allow a cooling medium to flow through the cooling member in the axial direction.
